(19) United States
(12) Patent Application Publication
(10) Pub. No.: US 2015/0217556 A1
(43) Pub. Date: Aug. 6, 2015

(54) SUBSTRATE PEELING DEVICE AND METHOD FOR PEELING SUBSTRATE

(71) Applicant: Samsung Display Co., Ltd., Yongin-city (KR)

(72) Inventors: Bo Ram LEE, Seongnam-si (KR); Sang Il KIM, Yongin-si (KR); Kwang Ho LEE, Seoul (KR); Hyun Jun KIM, Seoul (KR); Kyu Jin CHO, Incheon (KR)

(21) Appl. No.: 14/303,364

(22) Filed: Jun. 12, 2014

(30) Foreign Application Priority Data
Feb. 3, 2014 (KR) 10-2014-0012196

(51) Int. Cl. B32B 43/00; B32B 38/10

(52) U.S. Cl. CPC B32B 43/006; B32B 38/10

(57) ABSTRACT

A substrate peeling device including an attachment/detachment unit attached to a first substrate and a second substrate, which is coupled to the first substrate, to peel the second substrate, a sensing unit configured to sense a speed at which the first substrate and the second substrate are peeled by the attachment/detachment unit, and a control unit configured to control the attachment/detachment unit to constantly maintain an angle at which the first substrate and the second substrate are peeled.

### CROSS-REFERENCE TO RELATED APPLICATION

This application claims priority from and the benefit of Korean Patent Application No. 10-2014-0012196, filed on Feb. 3, 2014, which is hereby incorporated by reference for all purposes as if fully set forth herein.

### BACKGROUND

1. Field

Exemplary embodiments of the present invention relate to a substrate peeling device and a method for peeling a substrate.

2. Discussion of the Background

As the global society enters the full-scale information age, display devices to process and display a large quantity of information have been developed at high speed. As a result, thin film transistor (TFT) liquid crystal displays (LCDs), which are lightweight, thin-filming, and have low power consumption, have recently been developed to substitute for the existing cathode ray tubes (CRTs).

The liquid crystal display includes a color filter substrate, an array substrate, and a liquid crystal layer formed between the color filter substrate and the array substrate.

The color filter substrate includes a color filter having red (R), green (G), and blue (B) sub-color filters, a black matrix provided between the sub-color filters to intercept light that permeates the liquid crystal layer, and a transparent common electrode applying a voltage to the liquid crystal layer.

On the array substrate, a gate line and a data line, which define a pixel region, are formed to be arranged vertically and horizontally. In this case, a thin film transistor functioning as a switching device is formed in a crossing region of the gate line and the data line, and a pixel electrode is formed in the pixel region.

In order to form a liquid crystal panel, the color filter substrate and the array substrate, which are configured as described above, are attached to face each other by a sealant that is formed on the outline of an image display region, and the attachment of the color filter substrate and the array substrate is performed through an attachment key that is formed on the color filter substrate or the array substrate.

Because such a liquid crystal display is widely used in portable electronic appliances, it is desirable to reduce the size and weight thereof, in order to improve portability of the electronic appliance. Further, since a large-area liquid crystal display has recently been produced, there has been an increasing demand for lighter weight and thinner filming to be used in the liquid crystal display.

Although there may be several methods for reducing the thickness or weight of the liquid crystal display, reduction of essential constituent elements of the liquid crystal display is restricted as a result of the structure of the liquid crystal display. Further, because such essential constituent elements have a low weight, it is very difficult to reduce the overall thickness or weight of the liquid crystal display through reduction of the weight of the essential constituent elements.

A method for reducing the thickness and weight of the liquid crystal display through reduction of the thicknesses of the color filter substrate and the array substrate constituting the liquid crystal panel has been actively researched. In this case, however, thin substrates may be used, but such thin substrates may be easily bent or broken, while the thin substrates are transported through unit processes, or while the unit processes are carried out with respect to the thin substrates.

In particular, a thin glass substrate may be frequently broken as a result of the application of a force, which is greater than the stress that the thin glass substrate can endure, to the thin glass substrate in the process of attaching a carrier substrate to the thin glass substrate, and separating the carrier substrate from the thin glass substrate, after completion of the attaching process.

The above information disclosed in this Background section is only for enhancement of understanding of the background of the invention and, therefore, it may contain information that does not constitute prior art.

### SUMMARY

Exemplary embodiments of the present invention provide a substrate peeling device, which enables a force to be applied to the substrate that is equal to or less than a stress that a thin glass substrate can endure.

Exemplary embodiments of the present invention also provide a method for peeling a substrate, which enables a force to be applied to the substrate that is equal to or less than a stress that a thin glass substrate can endure.

Exemplary embodiments of the present invention also provide a method for peeling a substrate, which can prevent breaking of the substrate that may occur in a process of attaching/detaching a thin glass substrate.

Additional features of the invention will be set forth in the description which follows, and in part will become apparent from the description, or may be learned from practice of the invention.

An exemplary embodiment of the present invention discloses a substrate peeling device including: an attachment/detachment unit attached to a first substrate and a second substrate, which is coupled to the first substrate, and configured to peel the second substrate; a sensing unit configured to sense a speed at which the first substrate and the second substrate are peeled by the attachment/detachment unit; and a control unit configured to control the attachment/detachment unit to constantly maintain an angle at which the first substrate and the second substrate are peeled.

An exemplary embodiment of the present invention also discloses a substrate peeling device including: an attachment/detachment unit attached to a first substrate and a second substrate, which is coupled to the first substrate, and configured to peel the second substrate; a sensing unit configured to sense a speed at which the first substrate and the second substrate are peeled by the attachment/detachment unit; a transport unit fixed to the first substrate and configured to transport the first substrate in one direction; and a control unit configured to control the attachment/detachment unit and the transport unit to constantly maintain an angle at which the first substrate and the second substrate are peeled.

An exemplary embodiment of the present invention also discloses a method for peeling a substrate, including: peeling a second substrate by attaching an attachment/detachment unit to a first substrate and the second substrate, which is coupled to the first substrate; and sensing a speed at which the first substrate and the second substrate are peeled, wherein an angle at which the first substrate and the second substrate are peeled is controlled to be constantly maintained.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram schematically illustrating the configuration of a substrate peeling device according to an exemplary embodiment of the present invention.

FIG. 2 is a perspective view illustrating a substrate peeling device according to an exemplary embodiment of the present invention.

FIG. 3 is a front view illustrating a substrate peeling device according to an exemplary embodiment of the present invention.

FIG. 4A and FIG. 4B are cross-sectional views of an attachment/detachment unit explaining an attachment of the attachment/detachment unit to a substrate in a substrate peeling device according to an exemplary embodiment of the present invention.

FIG. 5 is a cross-sectional view illustrating a coupling state of a first substrate and a second substrate.

FIG. 6 is a flowchart explaining peeling of a first substrate and a second substrate according an exemplary embodiment of the present invention.

FIGS. 7 to 10 are cross-sectional views explaining peeling of a first substrate and a second substrate according an exemplary embodiment of the present invention.

FIG. 11 is a view explaining peeling of a first substrate and a second substrate at an angle according an exemplary embodiment of the present invention.

FIG. 12 is a diagram explaining peeling of a first substrate and a second substrate at an angle according an exemplary embodiment of the present invention.

FIG. 13 is a block diagram schematically illustrating the configuration of a substrate peeling device according to an exemplary embodiment of the present invention.

FIG. 14 is a perspective view illustrating a substrate peeling device according to an exemplary embodiment of the present invention.

FIG. 15 is a front view illustrating a substrate peeling device according to an exemplary embodiment of the present invention.

FIG. 16 is a flowchart explaining peeling of a first substrate and a second substrate according an exemplary embodiment of the present invention.

FIG. 17 is a flowchart explaining peeling of a first substrate and a second substrate at an angle according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of elements may be exaggerated for clarity. Like reference numerals in the drawings denote like elements.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

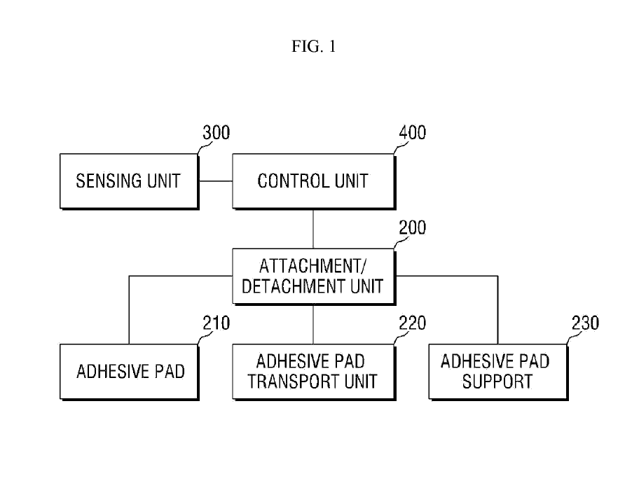

Referring to FIGS. 1-3, a substrate peeling device according to an exemplary embodiment of the present invention may include an attachment/detachment unit 200 attached to first mother substrate 101, first auxiliary substrate 111, second mother substrate 102, and second auxiliary substrate 112. The second mother substrate 102 and the second auxiliary substrate 112 are coupled to the first mother substrate 101 and the first auxiliary substrate 111, so as to peel apart the second substrates 102 and 112. The substrate peeling device may further include a sensing unit 300 configured to sense a speed at which the second mother substrate 102 and the second auxiliary substrate 112 are peeled by the attachment/detachment unit 200; and a control unit 400 configured to control the attachment/detachment unit 200 to constantly maintain a peeling angle at which the second mother substrate 102 and the second auxiliary substrate 112 are peeled apart.

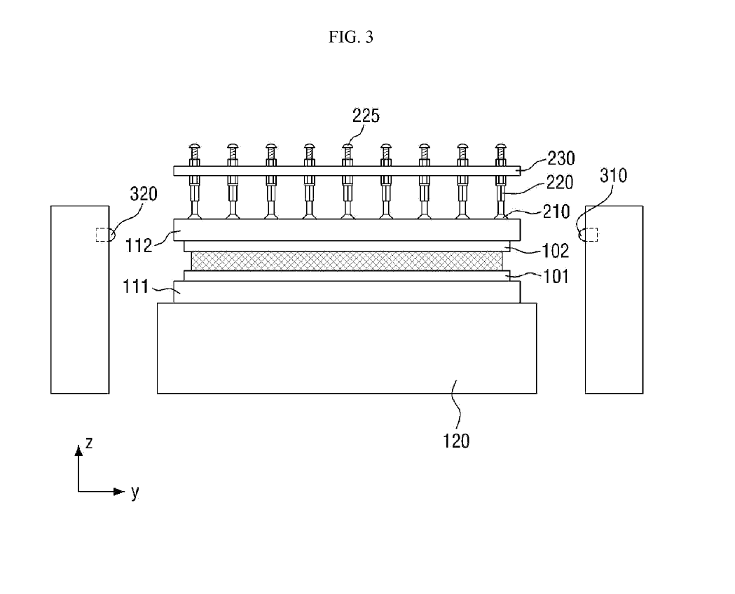

The attachment/detachment unit 200 may include an adhesive pad 210, an adhesive pad transport unit 220, and an adhesive pad support 230, as shown in FIG. 3. The attachment/detachment unit 200 may be attached to the second auxiliary substrate 112 of a liquid crystal panel 100 by a vacuum force using the adhesive pad 210. After the attachment/detachment unit 200 is attached to the second auxiliary substrate 112, the adhesive pad transport unit 220 may move the adhesive pad 210 upward/downward to peel apart the second auxiliary substrate 112 and the second mother substrate 102. Further, the adhesive pad transport unit 220 may be supported by the adhesive pad support 230, and may form an angle with respect to the first mother substrate 101 and the first auxiliary substrate 111 according to movement of the adhesive pad support 230. The adhesive pad support 230 may include support pads 235 extending in a first direction y, and the support pads 235 may be successively arranged in a second direction x. Further, each of the support pads 235 may be fixed to at least one of adhesive pads 210.

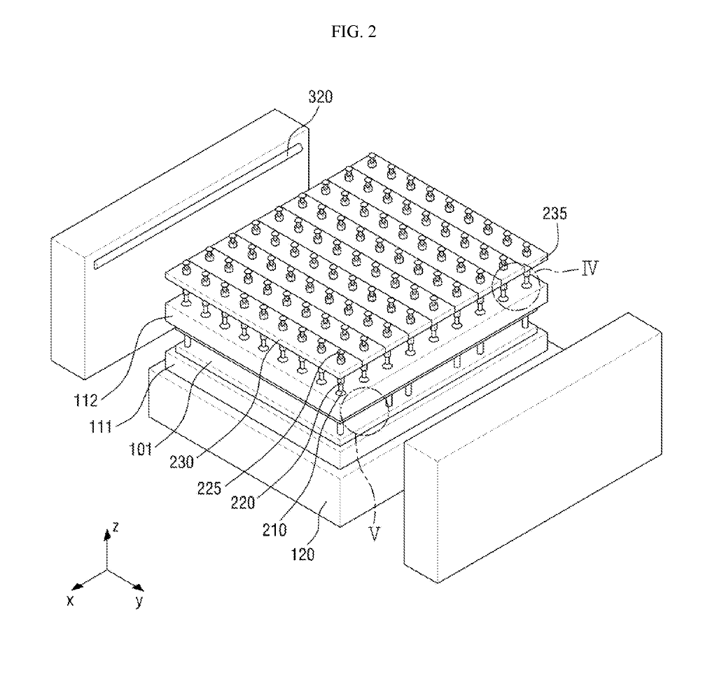

The sensing unit 300 may include a first sensor 310 and a second sensor 320. The first sensor 310 can sense a speed at which the second auxiliary substrate 112 is peeled apart from the second mother substrate 102 in the second direction as the adhesive pad 210 is successively adhered in the second direction. The second sensor 320 can sense a speed at which the adhesive pad 210 is moved in a third direction (z-direction in FIG. 2 to be described later) by the adhesive pad transport unit 220. The first sensor 310 and the second sensor 320 may be implemented by a CCD camera or a CMOS camera.

The control unit 400 may determine whether the speed (hereinafter “V₁”) at which the second auxiliary substrate 112 is peeled off the second mother substrate 102 in the second direction, and which is sensed and acquired by the sensing unit 200, is equal to the speed (hereinafter “V₂”) at which the second auxiliary substrate 112 is peeled off in the third direction (z-direction in FIG. 2 to be described later) by the adhesive pad transport unit 220. If V₁ and V₂ differ, the control unit 400 may control the adhesive pad transport unit 220 and the adhesive pad support 230 to maintain V₁ and V₂ at the same level. That is, if the levels of V₁ and V₂ are equal, the angle formed between the second auxiliary substrate 112 and the second mother substrate 102 can be kept constant. Thus, the stress that is applied to the second mother substrate 102 and the second auxiliary substrate 112 can be kept constant. The peeling angle should be controlled such that the stress that is applied to the second auxiliary substrate 112 becomes equal to or less than 90 MPa, and in this exemplary embodiment, the peeling angle may controlled to be equal to or less than 45°.

Referring to FIGS. 2 and 3, a table 120 may be utilized to fix the liquid crystal panel 100. That is, the liquid crystal panel 100 may be seated and fixed onto the table 120. The table 120 may be, for example, a stage or a transport rail of a display device manufacturing apparatus. The table 120 may be a rectangular prism. The width of the table 120 may be equal to or greater than the width of the substrate 100. The table 120 and the liquid crystal panel 100 may be fixed to each other by a vacuum force, electrostatic force, or surface tension, for example.

The liquid crystal panel 100 may include a first mother substrate 101, a second mother substrate 102, a first auxiliary substrate 111, and a second auxiliary substrate 112. The first auxiliary substrate 111 and the second auxiliary substrate 112, which are respectively attached to the first mother substrate 101 and the second mother substrate 102 to be processed, should be separated from the first mother substrate 101 and the second mother substrate 102.

The first mother substrate 101 and the second mother substrate 102 may be attached to each other in a manner such that the second mother substrate 102, on which color filter substrates (not shown) are formed, is laminated on the first mother substrate 101, on which thin film transistor array substrates (not shown) are formed. However, the first and second mother substrates 101 and 102 may be attached to each other in a manner such that the first mother substrate 101, on which the thin film transistor array substrates are formed, is laminated on the second mother substrate 102, on which the color filter substrates are formed.

The first and second mother substrates 101 and 102 are seated on the table 120 so that the second auxiliary substrate 112 faces upward. Adhesive pads 210, an adhesive pad transport unit 220 supporting the adhesive pads 210, and an adhesive pad support 230 attached to the adhesive pad transport unit 220 may be installed on the first and second mother substrates 101, 102.

Further, although not illustrated in the drawing, the substrate peeling device may further include an alignment unit to align the first and second mother substrates 101 and 102 seated on the table 120 and the attachment/detachment unit 200, and a vacuum chuck fixing the first and second aligned mother substrates 101 and 102.

The attachment/detachment unit 200 may include the adhesive pads 210, the adhesive pad transport unit 220, and the adhesive pad support 230. After being aligned with the liquid crystal panel 100, the attachment/detachment unit 200 may attach the second auxiliary substrate 112 and the adhesive pads 210 to each other by a vacuum force. After the attachment/detachment unit 200 is attached to the second substrate 112, the adhesive pad transport unit 220 may move the adhesive pad 210 upward/downward to peel the second auxiliary substrate 112 from the second mother substrate 102. Further, the adhesive pad transport unit 220 may be supported by the adhesive pad support 230, and may form an angle with respect to the first substrates 101 and 111 according to the movement of the adhesive pad support 230. The adhesive pad support 230 may include support pads 235 that are formed to extend in the first direction y, and the support pads 235 may be successively arranged in the second direction x. The attachment/detachment, upward/downward transporting speed, and upward/downward transporting distance of the respective adhesive pads 210 may be controlled by the control unit 400. Further, the angle that is formed between the support pads 235 and the first substrates 101, 111 may be controlled by the control unit 400.

The sensing unit 300 may include a first sensor 310 and a second sensor 320. The first sensor 310 and the second sensor 320 may be formed at the same height as that at which the second auxiliary substrate 112 and the second mother substrate 102 are formed. Because the adhesive pads 210 are successively peeled in the second direction x, the first sensor may sense a speed V₁ at which the second auxiliary substrate 112 is peeled off from the second mother substrate 102 in the second direction x by sensing of the speed at which the adhesive pads 210 are successively peeled in the second direction x. The first sensor 310 may sense the speed at which the adhesive pads are successively attached in the second direction x or the speed at which the second auxiliary substrate 112 and the second mother substrate 102 are peeled in the second direction x. The first sensor 310 can sense, for example, the speed at which the second auxiliary substrate 112 and the second mother substrate 102 are peeled in the second direction x.

The second sensor 320 may sense the speed at which the adhesive pads 210 are peeled in the third direction (z-direction in FIG. 2) by the adhesive pad transport unit 220. The second sensor 320 may sense the speed at which the adhesive pad transport unit 220 ascends, or the speed at which the second auxiliary substrate 112 and the second mother substrate 102 are peeled in the third direction z. However, the second sensor 320 can sense, for example, the speed at which the second auxiliary substrate 112 and the second mother substrate 102 are peeled in the second direction x.

The first sensor 310 and the second sensor 320 may include a CCD camera or a CMOS camera.

The first sensor 310 and the second sensor 320 may, for example, include a detector, such as an ultrasonic detector. The first sensor 310 and the second sensor 320 can sense the speed in the respective directions.

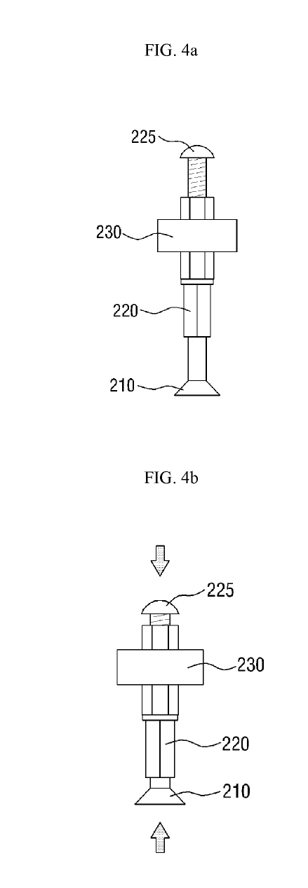

FIGS. 4A and 4B are cross-sectional views of an attachment/detachment unit explaining an attachment of the attachment/detachment unit to a substrate in a substrate peeling device according to an exemplary embodiment of the present invention.

Referring to FIGS. 4A and 4B, the attachment/detachment unit 200 may include the adhesive pad 210, the adhesive pad transport unit 220, and the adhesive pad support 230. The adhesive pad 210 may be attached to the second auxiliary substrate 112 by a vacuum force. That is, when the adhesive pad 210 is seated on the second auxiliary substrate 112, the adhesive pad 210 may be attached to the second auxiliary substrate 112 by the vacuum force provided by a vacuum pump (not illustrated) that is controlled by the control unit 400.

FIG. 4A illustrates a part of the attachment/detachment unit 200 before the adhesive pad transport unit 220 moves in the third direction z, and FIG. 4B illustrates a part of the attachment/detachment unit 200 after the adhesive pad transport unit 220 moves in the third direction z. The adhesive pad transport unit 220 and the transport adjustment unit 225 may move symmetrically with respect to the adhesive pad support 230. That is, if a length of the transport adjustment unit 225 is reduced, a length of the adhesive pad transport unit 220 is also reduced, while if the transport adjustment unit 225 is lengthened, the adhesive pad transport unit 220 is also lengthened. If the adhesive pad support 230 includes a plurality of support pads 235, the neighboring support pads 235 may be separated from each other in the second direction x, and the respective support pads 235 may form different angles with respect to the second support substrate 112. However, the adhesive pad 210 may be transported in the third direction z even if a part of the above-described configurations is omitted.

The adhesive pad transport unit 220 and the support pad 235 may be controlled by the control unit 400.

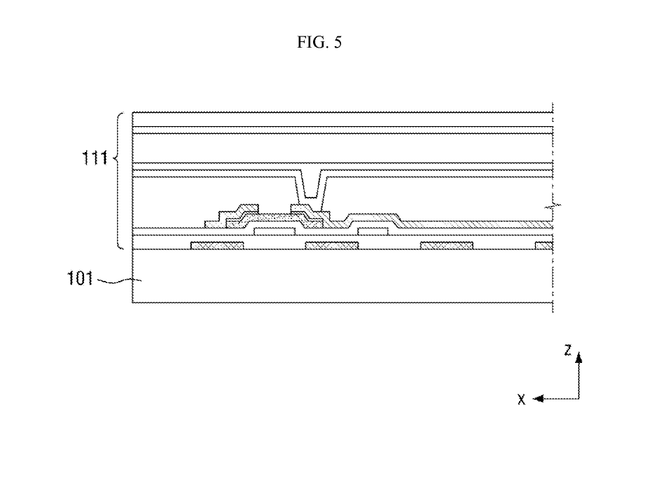

FIG. 5 is a cross-sectional view illustrating a coupling state of a first substrate and a second substrate.

Referring to FIG. 5, a first mother substrate 101, which includes a pixel electrode, a common electrode, a liquid crystal layer, and an insulating layer, is attached onto the first auxiliary substrate 111. That is, the panel of the thin display device may also have the same structure as the structure of a general liquid crystal panel that includes thin film transistors. However, the thin display device may include a general structure of a display device, such as an organic light emitting display or an electrophoretic display.

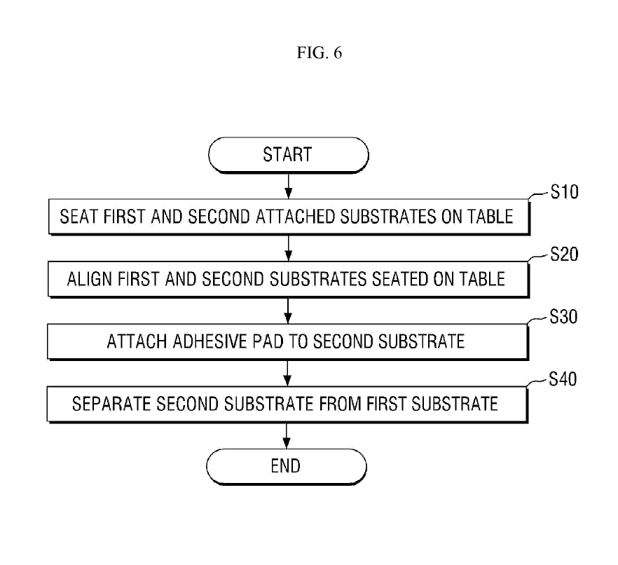

FIG. 6 is a flowchart explaining peeling of a first substrate and a second substrate according an exemplary embodiment of the present invention.

It is necessary to separate first and second auxiliary substrates 111 and 112 from first and second attached mother substrates 101 and 102. For this, the first and second attached mother substrates 101 and 102 may be seated on a table 120 (S10).

In this case, the first and second attached mother substrates 101 and 102 may be in a state where the second mother substrate 102, on which color filter substrates are formed, is laminated to the first mother substrate 101, on which thin film transistor array substrates are formed.

Although not illustrated in the drawings, the substrate peeling device may further include an alignment unit for aligning the first and second mother substrates 101 and 102 and a vacuum pad unit, an adhesive pad transport unit moving the vacuum pad unit upward/downward, and a vacuum chuck fixing the first and second aligned mother substrates 101 and 102.

The first and second mother substrates 101 and 102, which are loaded on the table 120, may be aligned to an attachment/detachment unit 200 positioned on an upper portion thereof by the above-described alignment unit (S20).

Next, an adhesive pad transport unit 220 of the aligned attachment/detachment unit may descend and may be attached to a second auxiliary substrate 112 using a vacuum pump (S30).

A control unit 400 may then control the adhesive pad transport unit 220 and a support pad 235 to peel the second auxiliary substrate 112 (S40). The shape of the second peeled auxiliary substrate 112 may be a straight-line shape, a fan shape, or a circular shape (S40), for example.

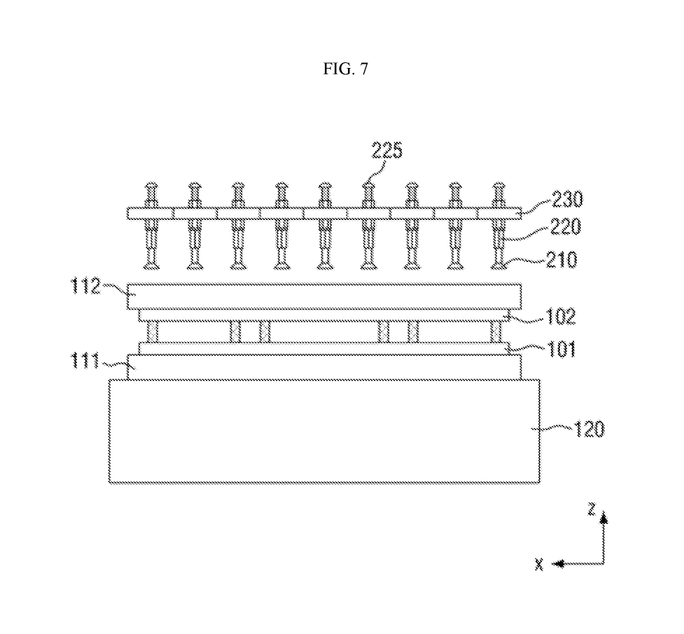

Hereinafter, with reference to FIGS. 7 to 10, a method for peeling a substrate according to an exemplary embodiment of the present invention will be described. For convenience in explanation, the same reference numerals are used for substantially the same elements as the respective elements illustrated in FIG. 2, and the duplicate explanation thereof will be omitted.

First, referring to FIG. 7, a liquid crystal panel 100, which includes a first auxiliary substrate 111, a first mother substrate 101, a second auxiliary substrate 112, and a second mother substrate 102, may be seated on a table 120. The table 120 and the liquid crystal panel 100 may be fixed by a force, such as a vacuum force or electrostatic force, and the liquid crystal panel 100 and the table 120 should not be separated from each other while a peeling process is performed.

An attachment/detachment unit 200 may be positioned on the liquid crystal panel 100 that is seated on the table 120. In this case, the attachment/detachment unit 200 may be positioned on the liquid crystal panel 100 through a connection arm that is not illustrated in FIG. 5, and the connection arm may make the attachment/detachment unit 200 descend to help seating of the attachment/detachment unit 200 on the second auxiliary substrate 112.

When an adhesive pad 210 is to be arrayed on the liquid crystal panel 100, a vacuum pump may prepare attachment of the adhesive pad 210 to the second auxiliary substrate 112. However, the vacuum pump may, for example, perform attachment after the adhesive pad 210 is arrayed on the liquid crystal panel 100.

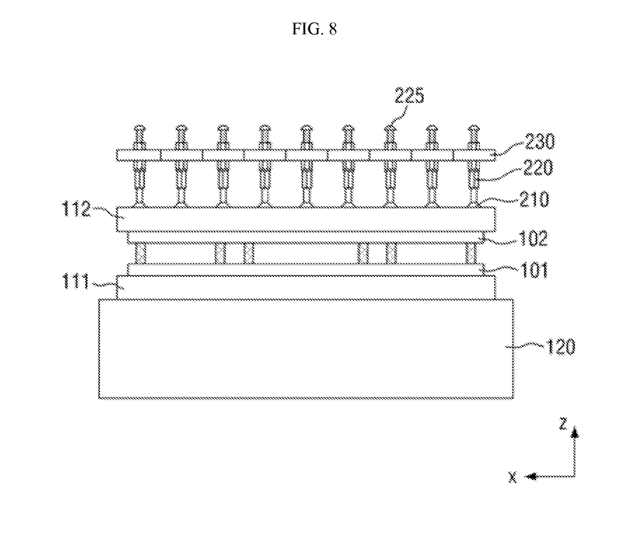

Referring to FIG. 8, the table 120 and the liquid crystal panel 100 are firmly fixed to each other, and the attachment/detachment unit 200 is also fixed to the second auxiliary substrate 112 by the vacuum force. The height of an adhesive pad transport unit 220 of the attachment/detachment unit 200 can be adjusted by a transport adjustment unit 225, and the transport adjustment unit 225 may operate from one end (illustrated as an end in the x-axis direction in FIG. 8) of the liquid crystal panel 100. The second auxiliary substrate 112 may be peeled off from the one end of the liquid crystal panel 100.

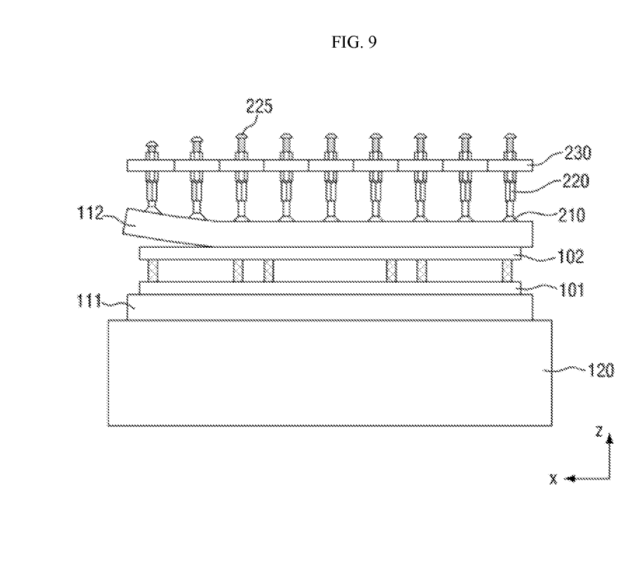

Referring to FIG. 9, if the transport adjustment unit 225 at the one end (illustrated as an end in the x-axis direction in FIG. 9) descends, an end of the adhesive pad transport unit 220 may ascend in the third direction (illustrated in the z-axis direction in FIG. 9). Because the adhesive pad 210 is formed at the end of the adhesive pad transport unit 220, the adhesive pad 210 may also ascend. The second auxiliary substrate 112, which is attached to the adhesive pad 210 by the vacuum force, is peeled off from the second mother substrate 102, starting from the one end (illustrated as an end in the x-axis direction in FIG. 9). The neighboring transport adjustment units 225 may descend by different heights, and thus, the neighboring adhesive pads 210 may transport the second auxiliary substrate 112 by different heights in the third direction (e.g., illustrated as the z-axis direction in FIG. 9).

Although not illustrated in FIG. 9, a first sensor 310 illustrated in FIGS. 2 and 3 may be formed at a boundary between the second auxiliary substrate 112 and the second mother substrate 102. The first sensor 310 may sense a speed at which the second auxiliary substrate 112 is peeled off from the second mother substrate 102 in the second direction x as the adhesive pads 210 are successively attached in the second direction. The time when the second auxiliary substrate 112 is peeled may be later than the time when the transport adjustment unit 225 operates to cause the adhesive pad transport unit 220 to ascend. However, if a gap between the neighboring adhesive pads 210 and time taken for the successive operation of the neighboring adhesive pads 210 are sensed, a speed V₁, at which the adhesive pads 210 are successively peeled off from the second auxiliary substrate 112 in the second direction x, can be sensed. Further, V₁ can be measured through measurement of the speed at which the point where the second auxiliary substrate 112 and the second mother substrate 102 are separated from each other in the second direction x.

Although not illustrated in FIG. 9, a second sensor 320 illustrated in FIGS. 2 and 3 may also be formed at the boundary between the second auxiliary substrate 112 and the second mother substrate 102. The second sensor 320 may sense a speed V₂ at which the adhesive pads 210 are attached to and lift the second auxiliary substrate 112 in the third direction. The time when the second auxiliary substrate 112 is peeled may be later than the time when the transport adjustment unit 225 operates to cause the adhesive pad transport unit 220 to ascend. However, the speed V₂, at which the adhesive pad transport unit 220 ascends, may be sensed or measured by measuring the speed at which the point where the second auxiliary substrate 112 and the second mother substrate 102 are separated from each other in the third direction z.

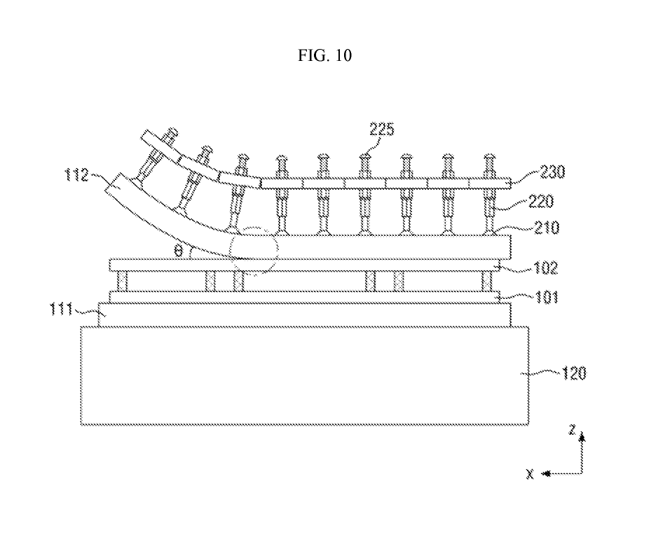

Referring to FIG. 10, the adhesive pad transport units 220 may include support pads 235, and may be separated from each other. If the adhesive pad transport units 220 are attached to and lift the second auxiliary substrate 112 upward to a height at which the adhesive pad transport units 220 ascend, an angle formed between the second auxiliary substrate 112 and the second mother substrate 102 may be unable to reach 45°, and it may take much more time in peeling apart the second auxiliary substrate 112 and the second mother substrate 102. Further, if the substrates are not peeled, an additional process may be required. In order to avoid such an additional process, the neighboring support pads 235 may be adjusted to form an angle. That is, by adjusting the support pads 235, the second auxiliary substrate 112 can be easily peeled off from the second mother substrate 102 to avoid the additional process. However, in the case of adjusting the angle θ of the support pads 235, the angle θ that is formed between the second auxiliary substrate 112 and the second mother substrate 102 becomes greater than 45°. As a result, a force greater than the stress of 90 MPa that the second auxiliary substrate 112 can endure, may be applied to the second auxiliary substrate 112. Accordingly, the control unit 400 may adjust the peeling speed so that V₂ does not become greater than V₁.

In the process as illustrated in FIG. 10, the second auxiliary substrate 112 may be in a fan shape or in a circular shape. However, any shape may suffice insofar as the angle θ that is formed between the second auxiliary substrate 112 and the second mother substrate 102 is less than 45°.

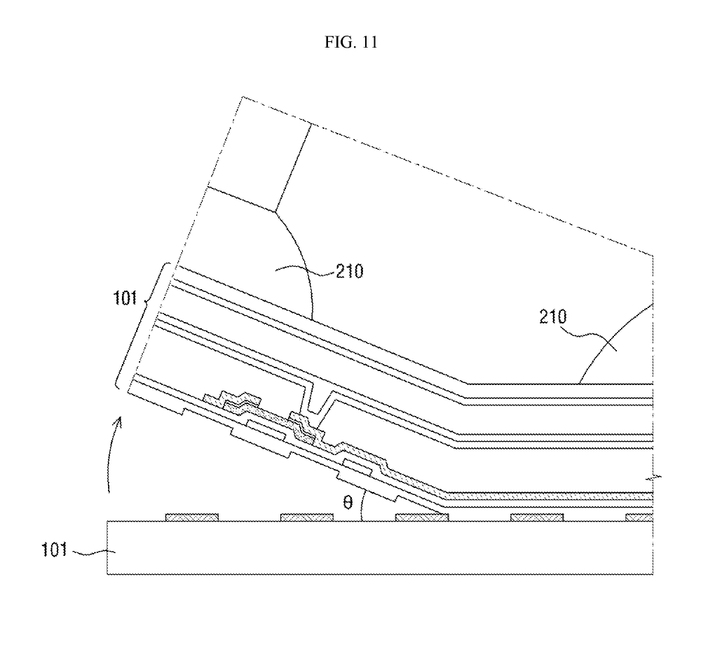

FIG. 11 is a view explaining peeling of a first substrate and a second substrate at an angle according an exemplary embodiment of the present invention.

Referring to FIG. 11, at a point where the first auxiliary substrate 112 and the first mother substrate 102 are peeled, a conductor, such as a common electrode or a pixel electrode, may be bent at an angle. Because the conductor generally has superior ductility, the switching characteristic of the thin film transistor is not affected by the above-described bending. Although FIG. 11 illustrates a process of peeling the first mother substrate 101 that is formed on the first auxiliary substrate 111, a process of peeling the second mother substrate 112 that is formed on the second mother substrate 102 may be performed in the same manner.

Further, the present invention is not limited thereto, and may include a general structure of a display device, such as an organic light emitting display or an electrophoretic display.

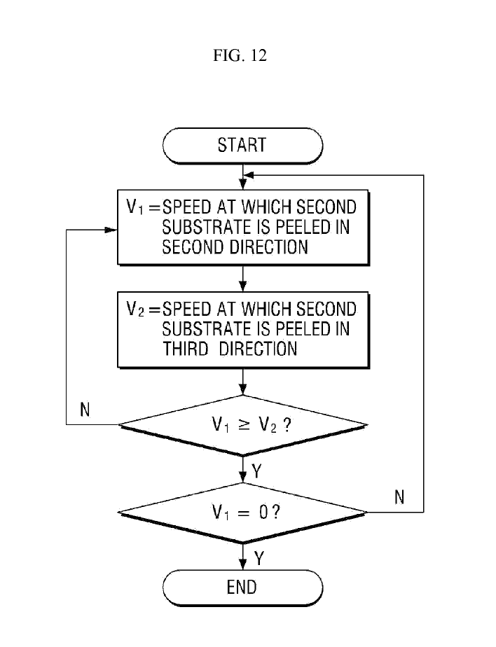

FIG. 12 is a flowchart explaining peeling of the first substrate and the second substrate at an angle according an exemplary embodiment of the present invention.

Referring to FIG. 12, the speed V₁ at which the second auxiliary substrate 112 is peeled in the second direction x by the first sensor 310, and the speed V₂ at which the second auxiliary substrate 112 is peeled in the third direction z by the second sensor 320. The sensed V₁ and V₂ are transmitted to the control unit 400.

The control unit 400 compares levels of V₁ and V₂, and if V₁ is equal to or greater than V₂ (V₁≧V₂), a force that is less than the stress that the second auxiliary substrate 112 can endure is applied to maintain the above-described angle. However, if the level of V₁ is “0”, the attachment/detachment unit 200 does not peel the second auxiliary substrate 112 any further. Thus, the sensing unit 300 may not sense V₁ and V₂. If the level of V₁ is not “0”, the sensing unit 300 periodically senses V₁ and V₂ in order to constantly keep the angle formed between the second auxiliary substrate 112 and the second mother substrate 102.

However, if V₂ is equal to or greater than V₁ (V₂≧V₁) as the result of the comparison, a force that is greater than the stress that the second auxiliary substrate 112 can endure is applied, and the above-described angle is not maintained. In this case, the control unit 400 may perform the peeling process with another pattern, and the sensing unit 300 may repeatedly sense V₁ and V₂ so that the second auxiliary substrate 112 and the second mother substrate 102 maintain the desired angle. However, if the level of V₁ is “0”, the attachment/detachment unit 200 may not peel the second auxiliary substrate 112 any further. Thus, the sensing unit 300 may not sense V₁ and V₂. If the level of V₁ is not “0”, the sensing unit 300 periodically senses V₁ and V₂ in order to constantly maintain the angle formed between the second auxiliary substrate 112 and the second mother substrate 102.

As described above, according to the substrate peeling device according to an exemplary embodiment of the present invention, the second auxiliary substrate 112 can be prevented from being broken in the peeling process through keeping of the constant angle at which the second auxiliary substrate 112 and the second mother substrate 102 are peeled.

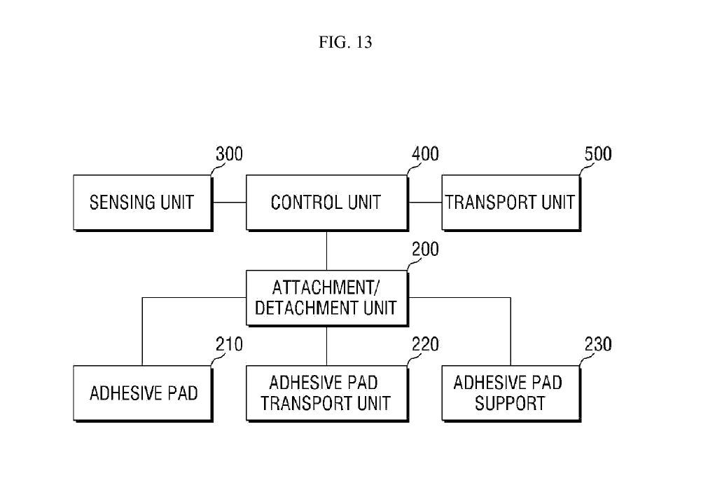

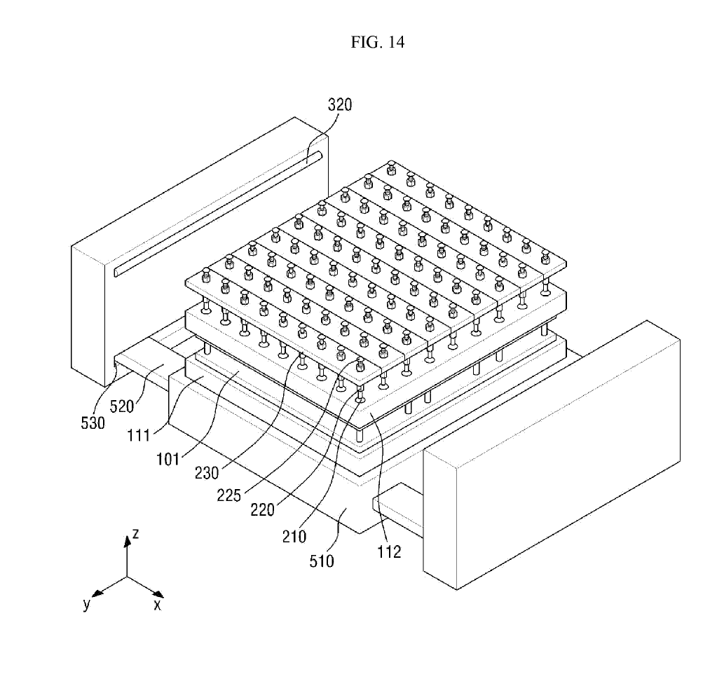

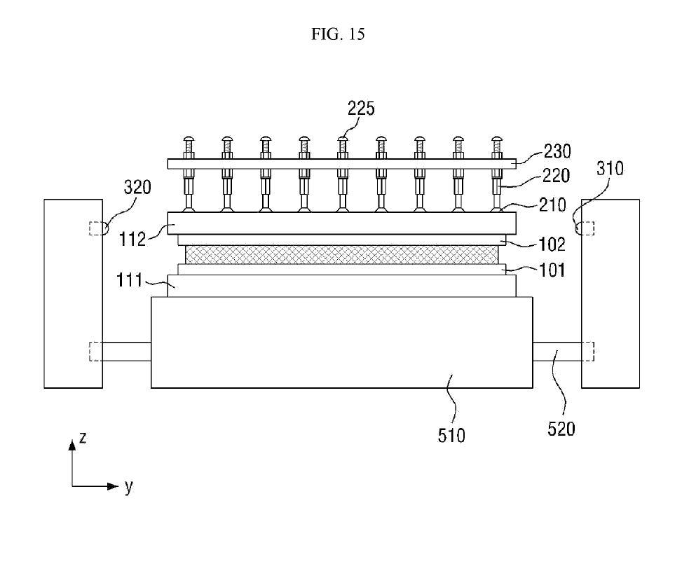

FIG. 13 is a block diagram schematically illustrating the configuration of a substrate peeling device according to another exemplary embodiment of the present invention. FIG. 14 is a perspective view illustrating a substrate peeling device according to another exemplary embodiment of the present invention, and FIG. 15 is a front view illustrating a substrate peeling device according to another exemplary embodiment of the present invention.

Referring to FIGS. 13 to 15, a substrate peeling device according to another exemplary embodiment of the present invention may include an attachment/detachment unit 200, a sensing unit 300, a control unit 400, and a transport unit 500. As compared with the substrate peeling device according to the exemplary embodiment of the present invention as described above, the substrate peeling device according this exemplary embodiment further includes the transport unit 500, and the table 120 of FIG. 2 is illustrated as a transport table 510 in FIG. 14. For convenience in explanation, the same reference numerals are used for substantially the same elements as the elements illustrated in FIG. 1, and duplicate explanations thereof will be omitted.

The sensing unit 300 may include a first sensor 310 and a second sensor 320. The first sensor 310 and the second sensor 320 may be formed at the same height as the height of a second auxiliary substrate 112 and a second mother substrate 102. Because the second auxiliary substrate 112 that is attached to an adhesive pad 210 is fixed onto a transport table 510 and moves in a direction opposite to a second direction (illustrated as x-direction in FIG. 14), the first sensor 310 may sense a speed V1′ at which the second auxiliary substrate 112 is peeled in a second direction x through sensing of the moving speed of the transport table 510 in the direction opposite to the second direction (illustrated as x-direction in FIG. 14). Further, the first sensor 310 may sense a speed at which the second auxiliary substrate 112 and the second mother substrate 102 are peeled in the second direction x. However, the present invention is not limited thereto, and the first sensor 310 can sense the speed V₁′ at which the second auxiliary substrate 112 and the second mother substrate 102 are peeled in the second direction.

The second sensor 320 can sense a speed V₂′ at which the adhesive pad 210 is peeled in a third direction (z-direction in FIG. 14) by an adhesive pad transport unit 220. The second sensor 320 may sense a speed at which the adhesive pad transport unit 220 ascends, or may sense a speed at which the second auxiliary substrate 112 and the second mother substrate 102 are peeled in the third direction. However, the present invention is not limited thereto, and the second sensor 320 can sense a speed at which the second auxiliary substrate 112 and the second mother substrate 102 are peeled in the second direction.

The first sensor 310 and the second sensor 320 may include a CCD camera or a CMOS camera.

However, the present invention is not limited thereto, and the first sensor and the second sensor may include a detector, such as an ultrasonic detector, and the first sensor and the second sensor can sense the speed in the respective directions.

The transport unit 500 may include a transport table 510, a connection arm 520, and a guide member 530.

The transport table 510 may be a stage or a transport rail of a display device manufacturing apparatus. The transport table 510 may move in the direction opposite to the second direction (illustrated as x-direction in FIG. 14) along the transport rail. That is, in performing the peeling process, the adhesive pad transport unit 220 may not successively peel and move the second auxiliary substrate 112, but may apply a constant force to individual adhesive pads 210 attached to the second auxiliary substrate 112 to move the transport table 510.

The connection arm 520 may connect the transport table 510 and the guide member 530 to each other, and may move the transport table 510 in the direction opposite to the second direction (illustrated as x-direction in FIG. 14) along the guide member 530.

The guide member 530, on which the connection arm 520 is seated, may guide the movement of the transport table 510 in the direction opposite to the second direction (illustrated as x-direction in FIG. 14).

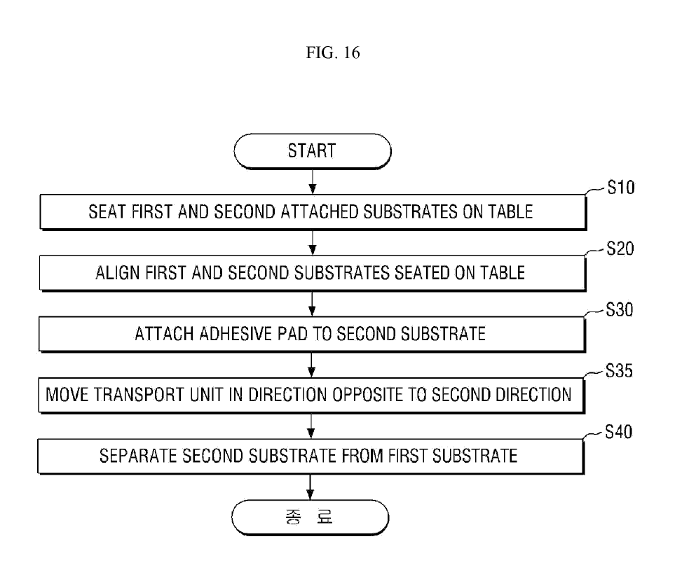

FIG. 16 is a flowchart explaining peeling of the first substrate and the second substrate according another exemplary embodiment of the present invention.

Referring to FIG. 16, it may be desirable to separate first and second auxiliary substrates 111 and 112 from first and second attached mother substrates 101 and 102. For this operation, the attached first and second mother substrates 101 and 102 may be seated on a transport table 510 (S10).

In this case, the second mother substrate 102, on which color filter substrates are formed, may be laminated on the first mother substrate 101, on which thin film transistor array substrates are formed.

Further, although not illustrated in the drawing, the substrate peeling device may further include an alignment unit for alignment between the first and second mother substrates 101 and 102 loaded on the transport table 510 and an attachment/detachment unit 200, an adhesive pad transport unit 220 moving the vacuum pad unit upward/downward, and a vacuum chuck fixing the first and second aligned mother substrates 101 and 102.

The first and second mother substrates 101 and 102, which are loaded on the transport table 510, may be aligned with an attachment/detachment unit 200 positioned on an upper portion thereof through the above-described alignment unit (S20).

Next, an adhesive pad transport unit 220 of the aligned attachment/detachment unit 200 may descend, and be attached to a second auxiliary substrate 112 using a vacuum pump (S30).

When the second auxiliary substrate 112 and the adhesive pad 210 are attached to each other, the adhesive pad transport unit 220 may ascend to apply a force to the second auxiliary substrate 112 in a third direction z, and the transport table 510 may move in the direction opposite to the second direction (illustrated as x-direction in FIG. 14) (S35).

Then, a control unit 400 may control the transport table 510, the adhesive pad transport unit 220, and a support pad 235 to peel the second auxiliary substrate 112. The shape of the second peeled auxiliary substrate 112 is not limited to a straight-line shape, but may be a fan shape or a circular shape (S40).

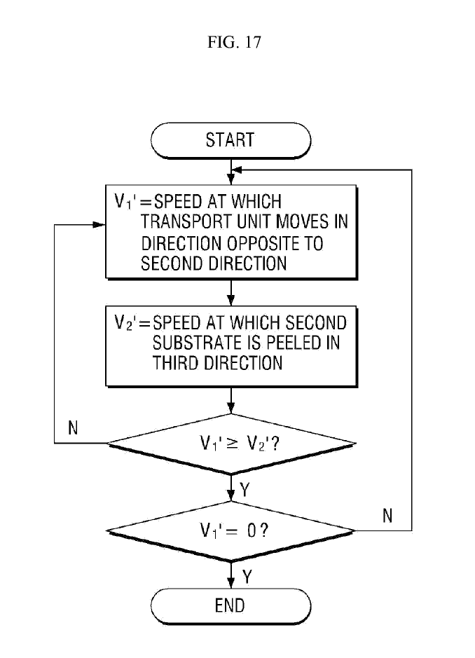

FIG. 17 is a flowchart explaining peeling of the first substrate and the second substrate at an angle according another exemplary embodiment of the present invention.

Referring to FIG. 17, the speed V₁′ at which the second auxiliary substrate 112 is peeled by the movement of the transport table 510 in a direction opposite to the second direction x by the first sensor 310, and the speed V₂′ at which the second auxiliary substrate 112 is peeled in the third direction z by the second sensor 320. The sensed V₁′ and V₂′ speeds are transmitted to the control unit 400.

The control unit 400 compares levels of V₁′ and V₂′, and if V₁′ is equal to or greater than V₂′ (V₁′≧V₂′), a force less than the stress that the second auxiliary substrate 112 can endure is applied to maintain the above-described angle θ. However, if the level of V₁ is “0”, the attachment/detachment unit 200 does not peel the second auxiliary substrate 112 any further, and thus, the sensing unit 300 may not sense V₁′ and V₂′. If the level of V₁′ is not “0”, the sensing unit 300 periodically senses V₁′ and V₂′ in order to constantly maintain the angle θ formed between the second auxiliary substrate 112 and the second mother substrate 102.

However, if V₂′ is equal to or greater than V₁′ (V₂′≧V₁′) as the result of the comparison, a force that is greater than the stress that the second auxiliary substrate 112 can endure is applied, and the above-described angle θ is not maintained. In this case, the control unit 400 may perform the peeling process with another pattern, and the sensing unit 300 may repeatedly sense V₁′ and V₂′ so that the second auxiliary substrate 112 and the second mother substrate 102 maintain the desired angle θ. However, if the level of V₁′ is “0”, it may be considered that the attachment/detachment unit 200 does not peel the second auxiliary substrate 112 any further, and thus, the sensing unit 300 may not sense V₁′ and V₂′. If the level of V₁′ is not “0”, the sensing unit 300 periodically senses V₁′ and V₂′ in order to constantly maintain the angle θ formed between the second auxiliary substrate 112 and the second mother substrate 102.

As described above, according to the substrate peeling device of the present invention, the second auxiliary substrate 112 can be prevented from being broken in the peeling process through keeping of the constant angle at which the second auxiliary substrate 112 and the second mother substrate 102 are peeled.

By sensing an angle at which the thin glass substrate is peeled off from the carrier substrate, it is possible to control a constant stress to be applied to the thin glass substrate. Further, by controlling a constant stress to be applied to the thin glass substrate without being affected by an external environment, the failure rate of the thin display device can be reduced during the manufacturing process thereof.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A substrate peeling device comprising:
an attachment/detachment unit configured to be attached to a first substrate and a second substrate, which is coupled to the first substrate, to peel apart the second substrate;
a sensing unit configured to sense a speed at which the first substrate and the second substrate are peeled apart by the attachment/detachment unit; and
a control unit configured to control the attachment/detachment unit to maintain a substantially constant peeling angle for the first substrate and the second substrate.

2. The substrate peeling device of claim 1, wherein the attachment/detachment unit comprises:
adhesive pads;
adhesive pad transport units configured to move the adhesive pads vertically; and
an adhesive pad support configured to support the adhesive pad transport units,
wherein the control unit is configured to control the vertical movement of the adhesive pad transport units.

3. The substrate peeling device of claim 2, wherein the adhesive pads are adhered to the second substrate by a vacuum force.

4. The substrate peeling device of claim 2, wherein the adhesive pad support comprises support pads that extend in a first direction, and are successively arranged along a second direction.

5. The substrate peeling device of claim 4, wherein the support pads are each attached to at least one of the adhesive pads that are successively arranged in the second direction.

6. The substrate peeling device of claim 4, wherein the sensing unit comprises:
a first sensor configured to sense a speed at which the first substrate and the second substrate are peeled apart in the second direction; and
a second sensor configured to sense a speed at which the first substrate and the second substrate are peeled in a third direction.

7. The substrate peeling device of claim 6, wherein the first sensor and the second sensor comprise a CCD camera or a CMOS camera.

8. The substrate peeling device of claim 6, wherein the control unit is configured to control the adhesive pad transport units and the adhesive pad support to control the speed at which the first substrate and the second substrate are peeled in the first direction and the speed at which the first substrate and the second substrate are peeled in the second direction.

9. A substrate peeling device comprising:
an attachment/detachment unit configured to be attached to a first substrate and a second substrate, which is coupled to the first substrate, to peel apart the second substrate;
a sensing unit configured to sense a speed at which the first substrate and the second substrate are peeled apart by the attachment/detachment unit;
a transport unit configured to transport the first substrate in one direction; and
a control unit configured to control the attachment/detachment unit and the transport unit to constantly maintain a peeling angle at which the first substrate and the second substrate are peeled apart.

10. The substrate peeling device of claim 9, wherein the attachment/detachment unit comprises:
adhesive pads;
adhesive pad transport units configured to move the adhesive pads vertically; and
an adhesive pad support configured to support the adhesive pad transport units,
wherein the control unit is configured to control the adhesive pads.

11. The substrate peeling device of claim 10, wherein the adhesive pads are attached to the second substrate by a vacuum force.

12. The substrate peeling device of claim 10, wherein the adhesive pad support comprises support pads that extend in a first direction, and the support pads are successively arranged along a second direction.

13. The substrate peeling device of claim 12, wherein the support pad is fixed to at least one of the adhesive pads that are successively arranged in the second direction.

14. The substrate peeling device of claim 12, wherein the sensing unit comprises:
a first sensor configured to sense a speed at which the transport unit transports in the second direction;
a second sensor configured to sense a speed at which the first substrate and the second substrate are peeled in a third direction; and
at least one of the first sensor and the second sensor comprises a CCD camera or a CMOS camera.

15. The substrate peeling device of claim 14, wherein the control unit is configured to control the adhesive pad transport units and the adhesive pad support to control the speed at which the first substrate and the second substrate are peeled in the second direction and the speed at which the first substrate and the second substrate are peeled in the third direction.

16. A method for peeling a substrate, comprising:
peeling apart a second substrate by attaching a first substrate and the second substrate, which is coupled to the first substrate, to an attachment/detachment unit; and
sensing a speed at which the first substrate and the second substrate are peeled,
wherein an angle at which the first substrate and the second substrate are peeled is controlled to be maintained at a substantially constant value.

17. The method of claim 16, wherein the peeling the second substrate comprises:
aligning adhesive pads on the second substrate;
attaching the adhesive pads to the second substrate by a vacuum force; and
lifting the second substrate by controlling vertical movement of the adhesive pads.

18. The method of claim 17, further comprising:
sensing a speed at which the first substrate and the second substrate are peeled in a second direction; and
sensing a speed at which the first substrate and the second substrate are peeled in a third direction.

19. The method of claim 18, wherein:
the speed at which the first substrate and the second substrate are peeled in the second direction is greater than or less than the speed at which the first substrate and the second substrate are peeled in the third direction; and
a ratio of the speed at which the first substrate and the second substrate are peeled in the second direction to the speed at which the first substrate and the second substrate are peeled in the third direction is maintained at a substantially constant value.
